(19) United States
(12) Patent Application Publication
(10) Pub. No.: US 2025/0171656 A1
(43) Pub. Date: May 29, 2025

(54) COATING COMPOSITIONS

(71) Applicant: PPG Industries Ohio, Inc., Cleveland, OH (US)

(72) Inventors: Liang Ma, Wuhan (CN); Chao Ma, Wuhan (CN); Ke Zhao, Shanghai (CN); Yongqiang Zhao, Fushun (CN); Yingying Song, Wuhan (CN); Hongying Zhou, Allison Park, PA (US)

(73) Assignee: PPG Industries Ohio, Inc., Cleveland, OH (US)

(21) Appl. No.: 18/714,225

(22) PCT Filed: Dec. 2, 2022
(86) PCT No.: PCT/US2022/080817

§ 371 Date: May 29, 2024

Related U.S. Application Data
(60) Provisional application No. 63/285,400, filed on Dec. 2, 2021.

(51) Int. Cl. C09D 175/06; C08K 3/013

(52) U.S. Cl. CPC C09D 175/06; C08K 3/013; C08K 2201/001

(57) ABSTRACT

Disclosed are compositions comprising a first component, a second component, and thermally conductive filler. The first component comprises an isocyanate functional prepolymer formed as a reaction product of reactants comprising a first polyisocyanate and a polyester polyol or a polyether polyol, the polyol comprising more than two hydroxyl functional groups. The second component comprises a polyol. Also disclosed are methods of coating a substrate and substrates comprising a coating formed on a surface from a composition disclosed herein. Also disclosed are batteries comprising a battery cell and any of the compositions disclosed herein in an at least partially cured state. Also disclosed are uses of the compositions disclosed herein.

### RELATED APPLICATIONS

This application claims priority to U.S. Provisional Application No. 63/285,400, filed on Dec. 2, 2021, and entitled “Coating Compositions,” incorporated herein in its entirety.

### FIELD

The present disclosure relates to compositions containing a thermally conductive filler.

### BACKGROUND

Coating compositions, including sealants and adhesives, are utilized in a wide variety of applications to treat a variety of substrates or to bond together two or more substrate materials.

The present disclosure is directed toward two-component compositions that contain thermally conductive fillers.

### SUMMARY

Disclosed herein are compositions comprising: a first component comprising an isocyanate functional prepolymer formed as a reaction product of reactants comprising a first polyisocyanate and a polyester polyol or a polyether polyol, the polyol comprising more than two hydroxyl functional groups; a second component comprising a polyol; and a thermally conductive filler.

Also disclosed are methods of coating a substrate comprising, contacting at least a portion of a surface of the substrate with one of the compositions disclosed herein.

Also disclosed are substrates comprising a coating on a surface, wherein the coating, in an at least partially cured state, comprises: (a) a thermal conductivity of at least 0.5 W/m-K measured using a Modified Transient Plane Source method conformed to ASTM D7984; (b) a lap shear strength of at least 0.1 MPa measured according to ASTM D1002-10 using an Instron 5567 machine in tensile mode with a pull rate of 10 mm per minute; (c) a tensile strength of 0.01 MPa measured according to ASTM D-412 using an Instron 5567 machine in tensile mode with a pull rate of 10 mm per minute; and/or (d) an elongation of 1% to 300% measured according to ASTM D-412 using an Instron 5567 machine in tensile mode with a pull rate of 10 mm per minute.

Also disclosed are batteries, comprising a battery cell and any of the compositions disclosed herein in an at least partially cured state.

Also disclosed are uses of the compositions disclosed herein for making a coating comprising, in an at least partially cured state: (a) a thermal conductivity of at least 0.5 W/m-K measured using a Modified Transient Plane Source method conformed to ASTM D7984; (b) a lap shear strength of at least 0.1 MPa measured according to ASTM D1002-10 using an Instron 5567 machine in tensile mode with a pull rate of 10 mm per minute; (c) a tensile strength of 0.01 MPa measured according to ASTM D-412 using an Instron 5567 machine in tensile mode with a pull rate of 10 mm per minute; and/or (d) an elongation of 1% to 300% measured according to ASTM D-412 using an Instron 5567 machine in tensile mode with a pull rate of 10 mm per minute.

Also disclosed are uses of a coating formed from the compositions disclosed herein to provide a substrate comprising: (a) a thermal conductivity of at least 0.5 W/m-K measured using a Modified Transient Plane Source method conformed to ASTM D7984; (b) a lap shear strength of at least 0.1 MPa measured according to ASTM D1002-10 using an Instron 5567 machine in tensile mode with a pull rate of 10 mm per minute; (c) a tensile strength of 0.01 MPa measured according to ASTM D-412 using an Instron 5567 machine in tensile mode with a pull rate of 10 mm per minute; and/or (d) an elongation of 1% to 300% measured according to ASTM D-412 using an Instron 5567 machine in tensile mode with a pull rate of 10 mm per minute.

### BRIEF DESCRIPTION OF THE DRAWINGS

FIG. 1 is a schematic of a top-down view of cylindrical battery cells.

FIG. 2 is a schematic of an exploded isometric view of an array of prismatic battery cells.

FIG. 3 is a schematic of a front view of an array of pouch battery cells.

FIG. 4 is a schematic of an isometric view of cylindrical cells positioned in a battery module.

FIG. 5 is a schematic of an exploded perspective view of a battery pack comprising multiple battery cells.

FIG. 6 is a schematic of an isometric view of (A) a battery cell, (B) a battery module, and (C) a batter pack.

FIG. 7 is a schematic of a perspective view of a battery pack.

FIG. 8 is a schematic of a cell to battery pack configuration.

FIG. 9 is a schematic of an isometric cut-out view of a cell to chassis battery assembly.

FIG. 10 is a bar graph showing the tensile strength and a line graph showing the elongation of adhesives formed from the compositions made in the Examples.

FIG. 11 is a bar graph showing the lap shear strength of adhesives formed from the compositions made in the Examples.

FIG. 12 is a bar graph showing the thermal conductivity of adhesives formed from the compositions made in the Examples.

### DETAILED DESCRIPTION

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described. As used herein, open-ended terms include closed terms such as consisting essentially of and consisting of.

In this application, the use of the singular includes the plural and plural encompasses singular, unless specifically stated otherwise. For example, although reference is made herein to “a” prepolymer and “a” polyol, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

As used herein, a “coating composition” refers to a composition, e.g., a solution, mixture, or a dispersion, that, in an at least partially dried or cured state, is capable of producing a film, layer, or the like on at least a portion of a substrate surface.

As used herein, a “sealant composition” refers to a coating composition, e.g., a solution, mixture, or a dispersion, that, in an at least partially dried or cured state, has the ability to resist atmospheric conditions such as temperature and moisture gradients and particulate matter, such as moisture and temperature and at least partially block the transmission of materials, such as particulates, water, fuel, and other liquids and gasses.

As used herein, a “gap filler” refers to a coating composition, e.g., a solution, mixture, or a dispersion, that, in an at least partially dried or cured state, fills a gap.

As used herein, an “adhesive composition” refers to a coating composition, e.g., a solution, mixture, or a dispersion, that, in an at least partially dried or cured state, produces a load-bearing joint, such as a load-bearing joint having a lap shear strength of at least 0.1 MPa measured according to ASTM D1002-10 using an Instron 5567 machine in tensile mode with a pull rate of 10 mm per minute.

As further defined herein, ambient conditions generally refer to room temperature (e.g. 23° C.) and humidity conditions or temperature and humidity conditions that are typically found in the area in which the composition is applied to a substrate, e.g., at 10° C. to 40° C. and 5% to 80% relative humidity, while slightly thermal conditions are temperatures that are slightly above ambient temperature but are generally below the curing temperature for the composition (i.e., in other words, at temperatures and humidity conditions below which the reactive components will readily react and cure, e.g., >40° C. and less than 220° C. at 20% to 80% relative humidity).

As used herein, the term “two-component” or “2K” refers to a composition in which at least a portion of the reactive components readily associate to form an interaction or react to form a bond (physically or chemically), and at least partially cure without activation from an external energy source, such as at ambient or slightly thermal conditions, when mixed. One of skill in the art understands that the two components of the composition are stored separately from each other and mixed just prior to application of the composition. Two-component compositions may optionally be heated or baked, as described below.

As used herein, the term “cure” or “curing”, means that the components that form the composition are crosslinked to form a film, layer, or bond. As used herein, the term “at least partially cured” means that at least a portion of the components that form the composition interact, react, and/or are crosslinked to form a film, layer, or bond. In the case of a 2K composition, the composition is at least partially cured or cured when the components of the composition are mixed resulting in the reaction of the reactive functional groups of the components of the composition.

As used herein, “M_{w}” refers to the weight average molecular weight, for example the theoretical value as determined by Gel Permeation Chromatography using Waters 2695 separation module with a Waters 410 differential refractometer (RI detector) and polystyrene standards, tetrahydrofuran (THF) used as the eluent at a flow rate of 1 ml min⁻¹, and two PL Gel Mixed C columns used for separation.

As used herein, “polymer” refers to oligomers, homopolymers, and copolymers.

As used herein, “small molecule” refers to a molecule that has an M_{w} of less than 1200 g/mol and that is not a polymer (i.e., is not composed of repeating monomer units).

As used herein, the term “thermally conductive filler” or “TC” filler means a pigment, filler, or inorganic powder that has a thermal conductivity of at least 5 W/m K at 25° C. measured according to ASTM D7984.

As used herein, the term “non-thermally conductive filler” or “NTC filler” means a pigment, filler, or inorganic powder that has a thermal conductivity of less than 5 W/m·K at 25° C. measured according to ASTM D7984.

As used herein, the term “electrically insulative filler” or “EI filler” means a pigment, filler, or inorganic powder that has a volume resistivity of at least 1 Ω·m (measured according to ASTM D257).

As used herein, the term “electrically conductive filler” or “EC filler” means a pigment, filler, or inorganic powder that has a volume resistivity of less than 1 Ω·m (measured according to ASTM D257).

As used herein, the term “solvent” refers to a molecule or a compound that has a high vapor pressure such as greater than 2 mm Hg at 25° C. determined by differential scanning calorimetry according to ASTM E1782 and is used to lower the viscosity of a resin but that does not have a reactive functional group capable of reacting with a functional group(s) on molecules or compounds in a composition.

As used herein, the term “reactive diluent” refers to a molecule or a compound that has a low vapor pressure such as 2 mm Hg or less at 25° C. determined by differential scanning calorimetry according to ASTM E1782 and is used to lower the viscosity of a resin but that has at least one functional group capable of reacting with a functional group(s) on molecules or compounds in a composition.

As used herein, the term “plasticizer” refers to a molecule or a compound that does not have a functional group capable of reacting with a functional group(s) on molecules or compounds in a composition and that is added to the composition to decrease viscosity, decrease glass transition temperature (Tg), and impart flexibility.

As used herein, unless indicated otherwise, the term “substantially free” means that a particular material is not purposefully added to a mixture or composition, respectively, and is only present as an impurity in a trace amount of less than 5% by weight based on a total weight of the mixture or composition, respectively. As used herein, unless indicated otherwise, the term “essentially free” means that a particular material is only present in an amount of less than 2% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material.

Disclosed herein is a composition comprising, or consisting essentially of, or consisting of: a first component; a second component; and a thermally conductive filler in the first component, the second component and/or a third component. As used herein, the composition “consists essentially of” a first component, a second component and optionally a third component when the maximum amount of other components is 5% by weight or less based on total weight of the composition.

The first component may comprise, or consist essentially of, or consist of an isocyanate functional prepolymer formed as a reaction product of reactants comprising a first polyisocyanate and a polyester polyol or a polyether polyol, wherein the polyol comprises more than two hydroxyl functional groups, and optionally a thermally conductive filler. As used herein, the first component “consists essentially of” an isocyanate-terminated compound, a polyester or polyether polyol and optionally a thermally conductive filler when the maximum amount of other components is 5% by weight or less based on total volume of the first component.

The second component may comprise, or consist essentially of, or consist of, a polyol and optionally a thermally conductive filler. As used herein, the second component “consists essentially of” a polyol and optionally a thermally conductive filler when the maximum amount of other components is 5% by weight or less based on total volume of the second component.

The composition may be a thermoset composition and may be a coating composition, such as a sealant composition, an adhesive composition, a gap filling composition, a putty, a molding compound, a 3D-printable composition or may be used in its at least partially dried or cured state to form a film, layer, or the like, or a part, such as a casted, molded, extruded, or machined part. As used herein, “thermoset” refers to a polymer that is irreversibly hardened by curing from a soft solid or viscous liquid prepolymer or resin.

### First Component of the Composition

As stated above, the first component of the composition may comprise an isocyanate functional prepolymer. The isocyanate functional prepolymer may be a reaction product of reactants comprising a first polyisocyanate and a polyester polyol or a polyether polyol, wherein the polyol has more than two hydroxyl functional groups. As used herein, “isocyanate functional prepolymer” refers to the reaction product of reactants comprising a polyisocyanate and a polyol. The isocyanate functional prepolymer has at least one free isocyanate functional group (NCO). The free isocyanate functional group may be terminal and/or may be on a side chain. Combinations of isocyanate functional prepolymers can be used.

The isocyanate functional prepolymer may have a M_{w} of at least 300 g/mol, such as at least 600 g/mol, such as at least 1,000 g/mol, such as at least 3,000 g/mol, and may have a weight average molecular weight of no more than 30,000 g/mol, such as no more than 20,000 g/mol, such as no more than 15,000 g/mol, such as no more than 10,000 g/mol. The isocyanate functional prepolymer may have a M_{w} of 300 g/mol to 30,000 g/mol, such as 600 g/mol to 20,000 g/mol, such as 1,000 g/mol to 15,000 g/mol, such as 3,000 g/mol to 10,000 g/mol.

The isocyanate functional prepolymer may have an isocyanate equivalent weight of at least 150 g/eq, such as at least 300 g/eq, such as at least 500 g/eq, such as at least 1,500 g/eq, and may have an isocyanate equivalent weight of no more than 15,000 g/eq, such as no more than 10,000 g/eq, such as no more than 7,500 g/eq, such as no more than 5,000 g/eq. The isocyanate functional prepolymer may have an isocyanate equivalent weight of 150 g/eq to 15,000 g/eq, such as 300 g/eq to 10,000 g/eq, such as 500 g/eq to 7,500 g/eq, such as 1,500 g/eq to 5,000 g/eq.

The isocyanate functional prepolymer may be present in the first component of the composition in an amount of at least 5 percent by weight based on total weight of the first component, such as at least 30 percent by weight, and may be present in the first component of the composition in an amount of no more than 100 percent by weight based on total weight of the first component, such as no more than 70 percent by weight. The isocyanate functional prepolymer may be present in the first component of the composition in an amount of 5 percent by weight to 100 percent by weight based on total weight of the first component, such as 30 percent by weight to 70 percent by weight.

As discussed above, the isocyanate functional prepolymer may comprise a reaction product of reactants comprising a first polyisocyanate and a polyol having more than two hydroxyl functional groups. The polyol may be a polyester polyol and/or a polyether polyol.

The first polyisocyanate can be a small molecule or polymeric containing at least two isocyanate functional groups (—N═C═O).

The first polyisocyanate may comprise C₂-C₂₀ aliphatic and/or aromatic polyisocyanates.

Suitable aliphatic polyisocyanates may include (i) alkylene isocyanates, such as: trimethylene diisocyanate; tetramethylene diisocyanate, such as 1,4-tetramethylene diisocyanate; pentamethylene diisocyanate, such as 1,5-pentamethylene diisocyanate and 2-methyl-1,5-pentamethylene diisocyanate; hexamethylene diisocyanate (“HDI”), commercially available as Demodur XP 2617 (Covestro), such as 1,6-hexamethylene diisocyanate and 2,2,4-and 2,4,4-trimethylhexamethylene diisocyanate, or mixtures thereof; heptamethylene diisocyanate, such as 1,7-heptamethylene diisocyanate; propylene diisocyanate, such as 1,2-propylene diisocyanate; butylene diisocyanate, such as 1,2-butylene diisocyanate, 2,3-butylene diisocyanate, 1,3-butylene diisocyanate, and 1,4-butylene diisocyanate; ethylene diisocyanate; decamethylene diisocyanate, such as 1,10-decamethylene diisocyanate; ethylidene diisocyanate; and butylidene diisocyanate. Aliphatic polyisocyanates may also include (ii) cycloalkylene isocyanates, such as: cyclopentane diisocyanate, such as 1,3-cyclopentane diisocyanate; cyclohexane diisocyanate, such as 1,4-cyclohexane diisocyanate, 1,2-cyclohexane diisocyanate, isophorone diisocyanate (“IPDI”), methylene bis(4-cyclohexylisocyanate) (“HMDI”); and mixed aralkyl diisocyanates such as tetramethylxylyl diisocyanates, such as meta-tetramethylxylylene diisocyanate (commercially available as TMXDI® from Allnex SA). Dimers, trimers, oligomers, and polymers of the above-mentioned polyisocyanates also may be used as the cyclotrimer of 1,6 hexamethylene diisocyanate (also known as the isocyanate trimer of HDI, commercially available as Desmodur N3300 (Covestro)).

Suitable aromatic polyisocyanates may include (i) arylene isocyanates, such as: phenylene diisocyanate, such as m-phenylene diisocyanate, p-phenylene diisocyanate, and chlorophenylene 2,4-diisocyanate; naphthalene diisocyanate, such as 1,5-naphthalene diisocyanate and 1,4-naphthalene diisocyanate. Aromatic polyisocyanates may also include (ii) alkarylene isocyanates, such as: methylene-interrupted aromatic diisocyanates, such as 4,4′-diphenylene methane diisocyanate (“MDI”), and alkylated analogs such as 3,3′-dimethyl-4,4′-diphenylmethane diisocyanate, and polymeric methylenediphenyl diisocyanate; toluene diisocyanate (“TDI”), such as 2,4-tolylene or 2,6-tolylene diisocyanate, or mixtures thereof, bitoluene diisocyanate; and 4,4-toluidine diisocyanate; xylene diisocyanate; dianisidine diisocyanate; xylylene diisocyanate; and other alkylated benzene diisocyanates.

Other suitable polyisocyanates for use as the first polyisocyanate may also include: triisocyanates, such as triphenyl methane-4,4′,4″-triisocyanate, 1,3,5-triisocyanato benzene, and 2,4,6-triisocyanato toluene; tetraisocyanates, such as 4,4′-diphenyldimethyl methane-2,2′,5,5′-tetraisocyanate; and polymerized polyisocyanates, such as tolylene diisocyanate dimers and trimers and the like.

The first polyisocyanate may have at least one functional group that is different from the isocyanate functional group(s).

As discussed above, the first polyisocyanate may be reacted with a polyester polyol and/or a polyether polyol to form the isocyanate functional prepolymer. The polyester polyol and/or a polyether polyol may include diols, triols, tetraols and higher functional polyols, i.e., compounds comprising five or more hydroxyl groups per molecule. The polyol may be linear, branched, cyclic, aliphatic and/or aromatic. The polyol may be a small molecule or a polymer. Combinations of polyester and/or polyether polyols also may be used.

The polyols may be based on a polyether chain derived from ethylene glycol, propylene glycol, butylene glycol, hexylene glycol and the like as well as mixtures thereof. The polyol may also be based on a polyester chain derived from ring opening polymerization of caprolactone (referred to as polycaprolactone-based polyols hereinafter). Suitable polyols may also include polyether polyols, polyester polyols, and combinations thereof.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista.

In addition, polyols based on dimer diols sold under the trade names Pripol®, Solvermol™ and Empol®, available from Cognis Corporation, or bio-based polyols such as castor oils. Bio-based polyols such as the tetrafunctional polyol Agrol 4.0, available from BioBased Technologies, may also be utilized.

In addition, the polyol may comprise a bio-based polyol derived from renewable raw materials. The bio-based polyols may comprise diols, triols or tetraols terminated with primary hydroxyl groups. Commercially available bio-based polyols include castor oil-based polyols, soybean oil-based polyols, cashew oil-based polyols, palm oil-based polyols and dimer acid-based polyols. Suitable examples include Elevance DC18™ polyols and Priplast™ polyols.

The isocyanate functional prepolymer may comprise the polyester polyol and/or the polyether polyol in an amount such that the prepolymer comprises an equivalent weight ratio of isocyanate groups to hydroxyl groups of at least 2:1, such as at least 10:1. The isocyanate functional prepolymer may comprise the polyester polyol and/or the polyether polyol in an amount such that the prepolymer comprises an equivalent weight ratio of isocyanate groups to hydroxyl groups of no more than 30:1, such as no more than 20:1. The isocyanate functional prepolymer may comprise the polyester polyol and/or the polyether polyol in an amount such that the prepolymer comprises an equivalent weight ratio of isocyanate groups to hydroxyl groups of 2:1 to 30:1, such as 10:1 to 20:1.

The isocyanate-functional prepolymer may be used in combination with any of the polyisocyanates described hereinabove (i.e., a “non-prepolymer isocyanate”). The non-prepolymer isocyanate may be the same or different from the polyisocyanate used to form the isocyanate functional prepolymer.

The non-prepolymer isocyanate may be present in the first component in an amount up to 95 percent by weight based on total weight of the first component. The non-prepolymer isocyanate may be present in the first component in an amount of at least 1 percent by weight based on total weight of the first component, such as at least 10 percent by weight, and may be present in the first component in an amount of no more than 95 percent by weight based on total weight of the first component, such as no more than 75 percent by weight. The non-prepolymer isocyanate may be present in the first component in an amount of 1 percent by weight to 95 percent by weight based on total weight of the first component, such as 10 percent by weight to 75 percent by weight.

Optionally, the first component also may comprise a thermally conductive filler. The thermally conductive filler may be any of the thermally conductive fillers described herein below. Combinations of thermally conductive fillers also may be used. That is, the first component may comprise a first thermally conductive filler and a second thermally conductive filler and optionally a third thermally conductive filler, etc.

The thermally conductive filler may be present in the first component in an amount up to 95 percent by weight based on total weight of the first component. The thermally conductive filler may be present in the first component in an amount of at least 1 percent by weight based on total weight of the first component, such as at least 30 percent by weight, and may be present in the first component in an amount of no more than 95 percent by weight based on total weight of the first component, such as no more than 80 percent by weight. The thermally conductive filler may be present in the first component in an amount of 1 percent by weight to 95 percent by weight based on total weight of the first component, such as 30 percent by weight to 80 percent by weight.

Optionally, the first component may be substantially free of an acid.

The first component may be present in the composition in an amount of at least 7 percent by weight based on total weight of the composition, such as at least 15 percent by weight, and may be present in the composition in an amount of no more than 97 percent by weight based on total weight of the composition, such as no more than 80 percent by weight. The first component may be present in the composition in an amount of 7 percent by weight to 97 percent by weight based on total weight of the composition, such as 15 percent by weight to 80 percent by weight.

### Second Component of the Composition

As stated above, the second component of the composition may comprise a polyol, such as a diol, a triol, a tetra-polyol or higher hydroxyl functionality. Suitable examples of polyols useful in the second component of the composition may be any of the polyols described hereinabove. Other suitable examples include polycaprolactone polyols, polycarbonate polyols, polyurethane polyols, poly vinyl alcohols, polymers containing hydroxyl functional acrylates, polymers containing hydroxyl functional methacrylates, polymers containing allyl alcohols, hydroxyl functional polybutadienes, and mixtures thereof. The polyol may be a C₁-C₁₁ polyol. The polyol of the second component may be the same as or different from the polyol described above that is useful in forming the isocyanate functional prepolymer.

The polyol of the second component may comprise a diol and/or a triol.

The diol may be present in the second component in an amount of at least 4 percent by weight based on total weight of the second component, such as at least 10 percent by weight, and may be present in the second component in an amount of no more than 100 percent by weight based on total weight of the second component, such as no more than 96 percent by weight. The diol may be present in the second component in an amount of 4 percent by weight to 100 percent by weight based on total weight of the second component, such as 10 percent by weight to 96 percent by weight.

The triol may be present in the second component in an amount of at least 4 percent by weight based on total weight of the second component, such as at least 10 percent by weight, and may be present in the second component in an amount of no more than 100 percent by weight based on total weight of the second component, such as no more than 96 percent by weight. The triol may be present in the second component in an amount of 4 percent by weight to 100 percent by weight based on total weight of the second component, such as 10 percent by weight to 96 percent by weight.

Other suitable polyols include the bio-based polyols described herein above.

The polyol may be present in the second component of the composition in an amount of at least 4 percent by weight based on total weight of the second component, such as at least 10 percent by weight, and may be present in the second component of the composition in an amount of no more than 100 percent by weight based on total weight of the second component, such as no more than 80 percent by weight. The polyol may be present in the second component of the composition in an amount of 4 percent by weight to 100 percent by weight based on total weight of the second component, such as 10 percent by weight to 80 percent by weight, such as 30 percent by weight to 60 percent by weight.

Optionally, the second component also may comprise a thermally conductive filler. The thermally conductive filler may be any of the thermally conductive fillers described herein below. Combinations of thermally conductive fillers also may be used. That is, the second component may comprise a first thermally conductive filler and a second thermally conductive filler and optionally a third thermally conductive filler, etc.

The thermally conductive filler may be present in the second component in an amount up to 96 percent by weight based on total weight of the second component. The thermally conductive filler may be present in the second component in an amount of at least 1 percent by weight based on total weight of the second component, such as at least 30 percent by weight, and may be present in the second component in an amount of no more than 95 percent by weight based on total weight of the second component, such as no more than 80 percent by weight. The thermally conductive filler may be present in the second component in an amount of 1 percent by weight to 96 percent by weight based on total weight of the second component, such as 30 percent by weight to 80 percent by weight.

The second component optionally may further comprise an accelerator.

The accelerator may be present in an amount of at least 0.001 percent by weight based on total weight of the second component, such as at least 0.005 percent by weight, and may be present in an amount of no more than 0.1 percent by weight, such as no more than 0.05 percent by weight. The accelerator may be present in an amount of 0.001 percent by weight to 0.1 percent by weight based on total weight of the second component, such as 0.005 percent by weight to 0.05 percent by weight.

The second component optionally may further comprise a second polyol. The second polyol may comprise a small molecule or a polyol. Suitable second polyols include such as ethylene glycol, butane diol, and propylene glycol.

The second polyol may be present in an amount of at least 0 percent by weight based on total weight of the second component, such as at least 0.5 percent by weight, and may be present in an amount of no more than 30 percent by weight, such as no ore than 20 percent by weight. The chain extender may be present in an amount of 0 percent by weight to 30 percent by weight based on total weight of the second component, such as 0.5 percent by weight to 20 percent by weight.

Optionally, the second component may be substantially free of an acid.

The second component may be present in the composition in an amount of at least 3 percent by weight based on total weight of the composition, such as at least 10 percent by weight, and may be present in the composition in an amount of no more than 93 percent by weight based on total weight of the composition, such as no more than 80 percent by weight. The second component may be present in the composition in an amount of 3 percent by weight to 93 percent by weight based on total weight of the composition, such as 10 percent by weight to 80 percent by weight.

### Third Component of the Composition

The composition optionally may further comprise a third component. The third component may comprise a thermally conductive filler and/or any of the additives described herein below. The thermally conductive filler may be any of the thermally conductive fillers described herein below. Combinations of thermally conductive fillers also may be used. That is, the third component may comprise a first thermally conductive filler and a second thermally conductive filler and optionally a third thermally conductive filler, etc.

The thermally conductive filler may be present in the third component in an amount up to 100 percent by weight based on total weight of the third component. The thermally conductive filler may be present in the third component in an amount of at least 0 percent by weight based on total weight of the third component, such as at least 30 percent by weight, and may be present in the third component in an amount of no more than 100 percent by weight based on total weight of the third component, such as no more than 80 percent by weight. The thermally conductive filler may be present in the third component in an amount of 0 percent by weight to 100 percent by weight based on total weight of the third component, such as 30 percent by weight to 80 percent by weight.

### Fillers

The compositions disclosed herein also comprise a thermally conductive filler comprising particles of a thermally conductive, electrically insulative filler (referred to herein as “TC/EI filler” and described in more detail below) and/or thermally conductive, electrically conductive filler (referred to herein as “TC/EC filler” and described in more detail below. The TC/EI and/or TC/EC filler may be present in the first component, the second component and/or a third component. The TC/EI and/or TC/EC filler may comprise organic or inorganic material and may comprise particles of a single type of filler material or may comprise a particles of two or more types of TC/EI filler and/or two or more types of TC/EC filler. That is, the thermally conductive filler may comprise particles of a first TC/EI filler and may further comprise particles of at least a second (i.e., a second, a third, a fourth, etc.) TC/EI filler that is different from the first TC/EI filler. Likewise, the conductive filler may comprise particles of a first TC/EC filler and may further comprise particles of at least a second (i.e., a second, a third, a fourth, etc.) TC/EC filler that is different from the first TC/EC filler. As used herein with respect to types of filler, reference to “first,” “second”, etc. is for convenience only and does not refer to order of addition to the composition or the like.

The thermally conductive filler present in the first component may be the same as or different from the thermally conductive filler present in the second component and/or the third component. Likewise, the thermally conductive filler present in the second component may be the same as or different from the thermally conductive filler present in the first component and/or third component.

Optionally, the thermally conductive filler may comprise a surface coating. The surface coating may comprise a silane and/or a multidentate polymer.

The thermally conductive filler may have a reported average particle size in at least one dimension of at least 0.01 μm, as reported by the manufacturer, such as at least 2 μm, such as at least 10 μm, and may have a reported average particle size in at least one dimension of no more than 500 μm as reported by the manufacturer, such as no more than 400 μm, such as no more than 300 μm, such as no more than 100 μm. The thermally conductive filler may have a reported average particle size in at least one dimension of 0.01 μm to 500 μm as reported by the manufacturer, such as 0.1 μm to 400 μm, such as 2 μm to 300 μm, such as 10 μm to 100 μm. Particle sizes may be measured by methods known to those skilled in the art, for example, using a scanning electron microscope (SEM), such as a Quanta 250 FEG SEM or an equivalent instrument. For example, powders may be dispersed on segments of carbon tape attached to aluminum stubs and coated with Au/Pd for 20 seconds. Samples then may be analyzed in an SEM under high vacuum (accelerating voltage 10 kV and spot size 3.0), measuring 30 particles from three different areas to provide an average particle size for each sample. One skilled in the art will recognize that there can be variations in this procedure that retain the essential elements of microscopic imaging and averaging of representative size.

Thermally conductive filler may comprise a plurality of particles each having, for example, a platy, spherical, or acicular shape, and agglomerates thereof. As used herein, “platy” refers to a two-dimensional material having a substantially flat surface and that has a thickness in one direction that is less than 25% of the largest dimension.

The thermally conductive filler may have a thermal conductivity of at least 5 W/m·K at 25° C. (measured according to ASTM D7984), such as at least 18 W/m·K, such as at least 55 W/m·K, and may have a thermal conductivity of no more than 3,000 W/m·K at 25° C., such as no more than 1,400 W/m·K, such as no more than 450 W/m·K. The thermally conductive filler may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K.

Filler particles may be electrically insulative. The particles of electrically insulative filler may have a volume resistivity of at least 1 Ω·m (measured according to ASTM D257), such as at least 10 Ω·m, such as at least 100 Ω·m.

Filler material may be electrically conductive. The particles of electrically conductive filler may have a volume resistivity of less than 1 Ω·m (measured according to ASTM D257), such as less than 0.1 Ω·m.

Suitable TC/EI filler materials include boron nitride (for example, commercially available as CarboTherm from Saint-Gobain, as CoolFlow and PolarTherm from Momentive, and as hexagonal boron nitride powder available from Panadyne), silicon nitride, or aluminum nitride (for example, commercially available as aluminum nitride powder available from Micron Metals Inc., and as Toyalnite from Toyal), metal oxides such as Boehmite, Pseudo Boehmite, aluminum oxide (for example, commercially available as Microgrit from Micro Abrasives, as Nabalox from Nabaltec, as Aeroxide from Evonik, and as Alodur from Imerys), magnesium oxide, beryllium oxide, silicon dioxide, titanium oxide, zinc oxide, nickel oxide, copper oxide, or tin oxide, metal hydroxides such as aluminum trihydrate, aluminum hydroxide or magnesium hydroxide, arsenides such as boron arsenide, carbides such as silicon carbide, minerals such as agate and emery, ceramics such as ceramic microspheres (for example, commercially available from Zeeospheres Ceramics or 3M), silicon carbide, and diamond. These fillers can also be surface modified, such as PYROKISUMA 5301K available from Kyowa Chemical Industry Co., Ltd. These thermally conductive fillers may be used alone or in a combination of two or more.

Suitable TC/EC filler materials include metals such as silver, zinc, copper, gold, or metal coated hollow particles, carbon compounds such as, graphite (such as Timrex commercially available from Imerys or ThermoCarb commercially available from Asbury Carbons), carbon black (for example, commercially available as Vulcan from Cabot Corporation), carbon fibers (for example, commercially available as milled carbon fiber from Zoltek), graphene and graphenic carbon particles (for example, xGnP graphene nanoplatelets commercially available from XG Sciences, and/or for example, the graphene particles described below), carbonyl iron, copper (such as spheroidal powder commercially available from Sigma Aldrich), zinc (such as Ultrapure commercially available from Purity Zinc Metals and Zinc Dust XL and XLP available from US Zinc), and the like. Examples of “graphenic carbon particles” include carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which is incorporated herein by reference. Other suitable graphenic carbon particles are described in U.S. Pat. No. 9,562,175, at 6:6 to 9:52, the cited portion of which are incorporated herein by reference. As used herein, the term “substantially flat” means planar; “curved” or “curled” materials deviate from planarity by having a non-zero curvature; and “creased” or “buckled” indicates that at least a portion of the area is thicker than one sheet, such that the plane is doubled or folded upon itself.

As discussed above, the thermally conductive filler may be present in the first component, the second component and/or the third component. The thermally conductive filler may be present in the composition in an amount of at least 20 percent by weight based on total weight of the composition, such as at least 30 percent by weight, and may be present in the composition in an amount of no more than 95 percent by weight, such as no more than 80 percent by weight. The thermally conductive filler may be present in the composition in an amount of 20 percent by weight to 95 percent by weight based on total weight of the composition, such as 30 percent by weight to 80 percent by weight.

Optionally, as discussed in more detail below, the first, second or third components also may comprise particles of non-thermally conductive, electrically insulative filler (referred to herein as “NTC/EI” filler). The filler materials may be organic or inorganic. The NTC/EI filler may comprise particles of a single type of filler or may comprise a particles of two or more types of NTC/EI fillers. That is, the thermally conductive filler may comprise particles of a first NTC/EI filler and may further comprise particles of at least a second (i.e., a second, a third, a fourth, etc.) NTC/EI filler that is different from the first NTC/EI filler.

The non-thermally conductive filler may have a thermal conductivity of less than 5 W/m·K at 25° C. (measured according to ASTM D7984), such no more than 3 W/m·K, such as no more than 1 W/mK, such as no more than 0.1 W/mK, such as no more than 0.05 W/mK, such as 0.02 W/m·K at 25° C. to 5 W/m·K at 25° C. Thermal conductivity may be measured as described above.

Suitable NTC/EI filler materials include but are not limited to mica, wollastonite, calcium carbonate, glass microspheres, clay, or combinations thereof.

As used herein, the term “mica” generally refers to sheet silicate (phyllosilicate) minerals. The mica may comprise muscovite mica. Muscovite mica comprises a phyllosilicate mineral of aluminum and potassium with the formula KAl₂(AlSi₃O₁₀)(F,OH)₂ or (KF)₂(Al₂O₃)₃(SiO₂)₆(H₂O). Exemplary non-limiting commercially available muscovite mica include products sold under the trade name DakotaPURE™, such as DakotaPURE# 700, DakotaPURE™ 1500, DakotaPURE™ 2400, DakotaPURE™ 3000, DakotaPURE™ 3500 and DakotaPURE™ 4000, available from Pacer Minerals. Wollastonite comprises a calcium inosilicate mineral (CaSiO₃) that may contain small amounts of iron, aluminum, magnesium, manganese, titanium and/or potassium. The wollastonite may have a B.E.T. surface area of 1.5 to 2.1 m²/g, such as 1.8 m²/g and a median particle size of 6 microns to 10 microns, such as 8 microns. Non-limiting examples of commercially available wollastonite include NYAD 400 available from NYCO Minerals, Inc.

The calcium carbonate (CaCO₃) may comprise a precipitated calcium carbonate or a ground calcium carbonate. The calcium carbonate may or may not be surface treated, such as treated with stearic acid. Non-limiting examples of commercially available precipitated calcium carbonate include Ultra-Pflex®, Albafil®, and Albacar HO® available from Specialty Minerals and Winnofil® SPT available from Solvay. Non-limiting examples of commercially available ground calcium carbonate include Duramite™ available from IMERYS and Marblewhite® available from Specialty Minerals.

Useful clay minerals include a non-ionic platy filler such as talc, pyrophyllite, chlorite, vermiculite, or combinations thereof.

The glass microspheres may be hollow borosilicate glass. Non-limiting examples of commercially available glass microspheres include 3M Glass bubbles type VS, K series, and S series available from 3M.

### Additives

The composition may optionally comprise an additive. Additives may be present in the first component, the second component and/or the third component. As used herein, an “additive” refers to a dispersant, a rheology modifier, a coupling agent, a water-absorbing agent, a dispersant, silica, a catalyst, a hydrolysis stabilizer, a potlife extender, a flame retardant, a tackifier, a thermoplastic polymer, a surface active agent, a reactive diluent, a corrosion inhibitor, a UV stabilizer, a colorant, a tint, a plasticizer, an antioxidant, pigments, a silane, a solvent, a silyl terminated polymer, and/or a moisture scavenger.

As used herein, “coupling agent” refers to a compound which provides a chemical bond between two dissimilar materials, such as an inorganic and an organic. Suitable examples include but not are limited to organosilanes, titanates such as isopropoxytri(ethylaminoethylamino)titanate, zirconates, 1,2 diketones, nitrogen heterocyclic compounds, cobalt compounds, and combinations thereof.

As used herein, “water absorbing agents” are chemicals that absorb moisture. Suitable examples of water absorbing agents include molecular sieves, calcium carbonate, calcium chloride, calcium sulfate, activated carbon, zeolites, silica gels and combinations thereof.

As used herein, “hydrolysis stabilizers” refer to chemicals that are capable of improving the hydrolysis resistance of the composition in order to extend the lifetime in application use. Suitable examples of useful hydrolysis stabilizers include carbodiimide-containing chemicals such as CARBODITE thermoplastic series powders and LANXESS's Stabaxol® product.

As used herein, “potlife extenders” are chemicals that allow components to be mixed together while extending the time to cure. Suitable examples include thiols, acetylacetone, 3,5-dimethylpyrazole and combinations thereof.

Suitable dispersants for use in the composition include fatty acid, phosphoric acid esters, polyurethanes, polyamines, polyacrylates, polyalkoxylates, sulfonates, polyethers, and polyesters, or any combination thereof. Non-limiting examples of commercially available dispersants include ANTI-TERRA-U100, DISPERBYK-102, DISPERBYK-103, DISPERBYK-111, DISPERBYK-171, DISPERBYK-2151, DISPERBYK-2059, DISPERBYK-2000, DISPERBYK-2117, and DISPERBYK-2118 available from BYK Company; and SOLSPERSE 24000SC, SOLSPERSE 16000 and SOLSPERSE 8000 hyperdispersants available from The Lubrizol Corporation. As used herein, the term “dispersant” refers to a substance that may be added to the composition in order to improve the separation of the thermally conductive filler particles by wetting the particles and breaking apart agglomerates.

Examples of suitable corrosion inhibitors include, for example, zinc phosphate-based corrosion inhibitors, for example, micronized Halox® SZP-391, Halox® 430 calcium phosphate, Halox® ZP zinc phosphate, Halox® SW-111 strontium phosphosilicate Halox® 720 mixed metal phosphor-carbonate, and Halox® 550 and 650 proprietary organic corrosion inhibitors commercially available from Halox. Other suitable corrosion inhibitors include Heucophos® ZPA zinc aluminum phosphate and Heucophos® ZMP zinc molybdenum phosphate, commercially available from Heucotech Ltd.

A corrosion inhibitor can comprise a lithium silicate such as lithium orthosilicate (Li₄SiO₄) and lithium metasilicate (Li₂SiO₃), MgO, an azole, or a combination of any of the foregoing. The corrosion inhibiting component may further comprise at least one of magnesium oxide (MgO) and an azole.

Useful rheology modifiers that may be used include polyamide, amide waxes, polyether phosphate, oxidized polyolefin, Castor wax and organoclay. Useful commercially available thixotropes include Disparlon 6500 available from King Industries, Garamite 1958 available from BYK Company, Bentone SD2 and Thixatrol® ST available from Elementis, and Crayvallac SLX available from Palmer Holland.

The reactive diluent may be a monomer, a small molecule, or a polymer, and may be mono-functional, bi-functional, or multi-functional. The reactive diluent may be an adhesion promoter or a surface active agent. Suitable examples of reactive diluent include propylene carbonate, oxazolidines, aldimines, ketimines and combinations thereof.

The reactive diluent may have a boiling point of greater than 100° C. at 1 atm, such as greater than 130° C., such as greater than 150° C., for example, and the reactive diluent may have a boiling point of less than 425° C. at 1 atm, such as less than 390° C., such as less than 360° C., for example. The reactive diluent can lower the viscosity of the mixture. The reactive diluent may have a viscosity of from 1 mPa·s to 4,000 mPa·s at 298° K and 1 atm according to ASTM D789, such as for example, from 1 mPa·s to 3,000 mPa·s, 1 mPa·s to 2,000 mPa·s, 1 mPa·s to 1,000 mPa·s, 1 mPa·s to 100 mPa·s, or 2 mPa's to 30 mPa·s.

Useful colorants or tints may include phthalocyanine blue.

Compositions provided by the present disclosure can comprise a flame retardant or combination of flame retardants. Certain TC materials described above such as aluminum hydroxide and magnesium hydroxide, for example, also may be flame retardants. As used herein, “flame retardant” refers to a material that slows down or stops the spread of fire or reduces its intensity. Flame retardants may be available as a powder that may be mixed with a composition, a foam, or a gel. In examples, when the compositions include a flame retardant, such compositions may form a coating on a substrate surface and such coating may function as a flame retardant.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

The composition optionally may comprise at least one plasticizer. Examples of plasticizers include diisononylphthalate (Jayflex™ DINP available from Exxon Mobil), diisodecylphthalate (Jayflex™ DIDP available from Exxon Mobil), and alkyl benzyl phthalate (Santicizer 278 available from Valtris); benzoate-based plasticizers such as dipropylene glycol dibenzoate (K-Flex® available from Emerald Performance Materials); and other plasticizers including terephthalate-based dioctyl terephthalate (DEHT available from Eastman Chemical Company), alkylsulfonic acid ester of phenol (Mesamoll available from Borchers), and 1,2-cyclohexane dicarboxylic acid diisononyl ester (Hexamoll DINCH available from BASF). Other plasticizers may include isophthalic hydrogenated terphenyls, quarterphenyls and higher or polyphenyls, phthalate esters, chlorinated paraffins, modified polyphenyl, naphthalene sulfonates, trimellitates, adipates, sebacates, maleates, sulfonamide, organophosphates, polybutene, and combinations of any of the foregoing. These plasticizers can be polymers such as polyacrylates.

As used herein, a “moisture scavenger” is a chemical that reacts with water in order to eliminate the effect of moisture. Suitable moisture scavengers include vinyltrimethoxysilane (Silquest A-171 from Momentive), vinyltriethoxysilane (Silquest A-151NT from Momentive), gamma-methacryloxypropyltrimethoxysilane (Silquest A-174NT available from Evonik), molecular sieves, calcium oxide (POLYCAL OS325 available from Mississippi Lime), oxazolidines (ZOLIDINE™ MS-Plus), p-toluenesulfonyl isocyanate (Additive Ti) or combinations thereof.

The composition also may comprise a solvent. Suitable solvents include toluene, methyl ethyl ketone, benzene, n-hexane, xylene, and combinations thereof.

The additive(s), if present at all, may be present in the composition in a total amount of at least 0 percent by weight based on total weight of the composition, such as at least 3 percent by weight, and may be present in the composition in a total amount of no more than 15 percent by weight based on total weight of the composition, such as no more than 10 percent by weight. The additive(s), if present at all, may be present in the composition in a total amount of 0 percent by weight to 15 percent by weight based on total weight of the composition, such as 3 percent by weight to 10 percent by weight.

### Compositions, Systems and Methods

The 2K compositions disclosed herein may comprise: a first component comprising an isocyanate functional prepolymer formed as a reaction product of reactants comprising a first polyisocyanate and a polyester polyol or a polyether polyol, the polyol comprising more than two hydroxyl functional groups; a second component comprising a polyol; and a thermally conductive filler. The thermally conductive filler and any of the optional additives described herein above may be present in the first component and/or the second component.

The 3K compositions disclosed herein may comprise: a first component comprising an isocyanate functional prepolymer formed as a reaction product of reactants comprising a first polyisocyanate and a polyester polyol or a polyether polyol, the polyol comprising more than two hydroxyl functional groups; a second component comprising a polyol; and a third component comprising a thermally conductive filler and any of the optional additives described herein above. Optionally, the additives and/or thermally conductive filler also may be present in the first component and/or the second component.

The first component may be present in the composition in a ratio by volume to the second component of 100:1 to 1:100.

The first and second components each may have a viscosity of no more than 10¹⁰ cp at a shear rate of 1/s measured by a rotational rheometer at 25° C. using a parallel plate with a diameter of 25 mm (1 mm gap), such as no more than 10⁹ cp, such as no more than 10⁸ cp, such as no more than 10⁷ cp, such as no more than 10⁶ cp, such as no more than 10⁵ cp, such as no more than 10⁴ cp. The first and second components each may have a viscosity of 5,000 cp to 500,000 cp at a shear rate of 1/s measured by a rotational rheometer at 25° C. using a parallel plate with a diameter of 25 mm (1 mm gap).

The compositions may have a total solids content of at least 50 percent by weight based on total weight of the composition, such as at least 60 percent by weight, such as at least 70 percent by weight, such as at least 80 percent by weight, such as at least 90 percent by weight, such as at least 95 percent by weight, such as at least 96 percent by weight, such as at least 97 percent by weight, such as at least 98 percent by weight, such as at least 99 percent by weight, such as 100 percent by weight. The compositions may have a total solids content of 50 percent by weight to 100 percent by weight based on total weight of the composition, such as 60 percent by weight to 100 percent by weight, such as 70 percent by weight to 100 percent by weight, such as 80 percent by weight to 100 percent by weight, such as 90 percent by weight to 100 percent by weight, such as 95 percent by weight to 100 percent by weight, such as 96 percent by weight to 100 percent by weight, such as 97 percent by weight to 100 percent by weight, such as 98 percent by weight to 100 percent by weight, such as 99 percent by weight to 100 percent weight. As used herein, “total solids” refers to the non-volatile content of the composition, i.e., materials which will not volatilize when heated to 105° C. and standard atmospheric pressure (101325 Pa) for 60 minutes.

In the case of a 2K composition, one of the components may be substantially free, or essentially free, or completely free, of filler materials, and in the case of a 3K composition, one or two of the components may be substantially free, or essentially free, or completely free, of filler materials.

The composition may be a low-VOC composition. As used herein, the term “low-VOC” refers to a composition having a theoretical VOC volume % of less than 7% by volume, such as less than 3% by volume, such as less than 2% by volume, such as less than 1% by volume, such as less than 0.5% by volume, based on total volume of the composition. VOC may be measured according to ASTM D3960 (after hearing the volatile components for 1 hour at 110° C.±5° C.).

Also disclosed are methods for preparing the compositions disclosed above. The method optionally may comprise mixing a first polyisocyanate and a polyester polyol or a polyether polyol having more than two hydroxyl functional groups to form an isocyanate functional prepolymer. The isocyanate functional prepolymer optionally may be mixed with a thermally conductive filler and/or an additive to form the first component. A polyol optionally may be mixed with a thermally conductive filler and/or an additive to form the second component. The first component and the second component and optionally a third component may be mixed to form a composition disclosed herein. Such mixing may be at a temperature of less than 50° C., such as from 0° C. to 50° C., such as from 15° C. to 35° C., such as at ambient temperature.

The composition described above may be applied alone or as part of a system that can be deposited in a number of different ways onto a number of different substrates. The system may comprise a number of the same or different films, coatings, or layers. A film, coating, or layer is typically formed when a composition that is deposited onto at least a portion of the substrate surface is at least partially dried or cured by methods known to those of ordinary skill in the art (e.g., under ambient conditions).

The composition can be applied to the surface of a substrate in any number of different ways, non-limiting examples of which include brushes, rollers, films, pellets, trowels, spatulas, dips, spray guns and applicator guns to form a coating on at least a portion of the substrate surface.

After application to the substrate(s), the composition may be cured. For example, the composition may be allowed to cure at room temperature or slightly thermal conditions, and for any desired time period (e.g., from 5 minutes to 1 hour) sufficient to at least partially cure the composition on the substrate(s).

Also disclosed are methods for treating a substrate comprising, or consisting essentially of, or consisting of, contacting at least a portion of a surface of the substrate with one of the compositions disclosed hereinabove. The composition may be cured to form a coating, layer, or film on the substrate surface under ambient conditions or slightly thermal conditions. The coating, layer, or film, may be, for example, a sealant, a gap filler, or an adhesive.

Also disclosed are methods for forming a bond between two substrates for a wide variety of potential applications in which the bond between the substrates provides particular mechanical properties related to lap shear strength. The method may comprise, or consist essentially of, or consist of, applying the composition described above to a first substrate; contacting a second substrate to the composition such that the composition is located between the first substrate and the second substrate; and curing the composition under ambient conditions or slightly thermal conditions. For example, the composition may be applied to either one or both of the substrate materials being bonded to form an adhesive bond therebetween and the substrates may be aligned and pressure and/or spacers may be added to control bond thickness. The composition may be applied to cleaned or uncleaned (i.e., including oily or oiled) substrate surfaces.

As stated above, the composition of the present disclosure also may form a sealant on a substrate or a substrate surface. The sealant composition may be applied to substrate surfaces, including, by way of non-limiting example, a vehicle body or components of an automobile frame or an airplane. The sealant formed by the compositions disclosed herein provides sufficient sound damping, tensile strength and tensile elongation. The sealant composition may be applied to cleaned or uncleaned (i.e., including oily or oiled) substrate surfaces. It may also be applied to a substrate that has been pretreated, coated with an electrodepositable coating, coated with additional layers such as a primer, basecoat, or topcoat. The coating composition may dry or cure at ambient conditions once applied to a substrate or substrates coated with coating compositions may optionally subsequently be baked in an oven to cure the coating composition.

The composition may be injected or otherwise placed in a die caster or a mould and at least partially dried or cured under ambient conditions or by exposure to an external energy source, for example such as by heating to a temperature of less than 180° C., such as less than 130° C., such as less than 90° C. to form a part or a member and optionally may be machined to a particular configuration.

### 3-D Printing

Alternatively, the composition may be casted, extruded, moulded, or machined to form a part or a member in at least partially dried or cured state.

The 2K compositions disclosed herein surprisingly may be used in any suitable additive manufacturing technology, such as extrusion, jetting, and binder jetting.

The present disclosure is also directed to the production of structural articles, such as by way of non-limiting example, sound damping pads, using three-dimensional printing. A three-dimensional article may be produced by forming successive portions or layers of an article by depositing the composition onto a substrate and thereafter depositing additional portions or layers of the composition over the underlying deposited portion or layer and/or adjacent the previously deposited portion or layer. Layers can be successively deposited adjacent a previously deposited layer to build a printed article. First and second components of the composition can be mixed and then deposited or the first and second components of the composition can be deposited separately. When deposited separately, the first and second components can be deposited simultaneously, sequentially, or both simultaneously and sequentially.

By “portions of an article” is meant subunits of an article, such as layers of an article. The layers may be on successive horizontal parallel planes. The portions may be parallel planes of the deposited material or beads of the deposited material produced as discreet droplets or as a continuous stream of material. The first and second components may each be provided neat or may also include a solvent (organic and/or water) and/or other additives as described below. First and second components provided by the present disclosure may be substantially free of solvent. By substantially free is meant that the first and second components comprise less than 5 wt %, less than 4 wt %, less than 2 wt %, or less than 1 wt % of solvent, where wt % is based on the total weight of the first component or the second component, as the case may be. Similarly, the composition provided by the present disclosure may be substantially free of solvent, such as having less than 5 wt %, less than 4 wt %, less than 2 wt %, or less than 1 wt % of solvent, where wt % is based on the total weight of the composition.

The first and second components may be mixed together and subsequently deposited as a mixture of components that react to form portions of an article. For example, two components may be mixed together and deposited as a mixture of components that react to form a thermoset by delivery of at least two separate streams of the components into a mixer such as a static mixer and/or a dynamic mixer to produce a single stream that is then deposited. The components may be at least partially reacted by the time a composition comprising the reaction mixture is deposited. The deposited reaction mixture may react at least in part after deposition and may also react with previously deposited portions and/or subsequently deposited portions of the article such as underlying layers or overlying layers of the article.

Two or more components can be deposited using any suitable equipment. The selection of suitable deposition equipment depends on a number of factors including the deposition volume, the viscosity of the composition and the complexity of the part being fabricated. Each of the two or more components can be introduced into an independent pump and injected into a mixer to combine and mix the two components. A nozzle can be coupled to the mixer and the mixed composition can be pushed under pressure or extruded through the nozzle.

A pump can be, for example, a positive displacement pump, a syringe pump, a piston pump, or a progressive cavity pump. The two pumps delivering the two components can be placed in parallel or placed in series. A suitable pump can be capable of pushing a liquid or viscous liquid through a nozzle orifice. This process can also be referred to as extrusion. A component can be introduced into the mixer using two pumps in series.

For F example, the first and second components can be deposited by dispensing materials through a disposable nozzle attached to a progressive cavity two-component dosing system such as a ViscoTec eco-DUO 450 precision dosing system, where the first and second components are mixed in-line. A two-component dosing system can comprise, for example, two progressive cavity pumps that separately dose reactants into a disposable static mixer dispenser or into a dynamic mixer. Other suitable pumps include positive displacement pumps, syringe pumps, piston pumps, and progressive cavity pumps. Upon dispensing, the materials of the first and second components form an extrudate which can be deposited onto a surface to provide an initial layer of material and successive layers on a base. The deposition system can be positioned orthogonal to the base, but also may be set at any suitable angle to form the extrudate such that the extrudate and deposition system form an obtuse angle with the extrudate being parallel to the base. The extrudate refers to the combined components, i.e., a composition, that have been mixed, for example, in a static mixer or in a dynamic mixer. The extrudate can be shaped upon passing through a nozzle.

The base, the deposition system, or both the base and the deposition system may be moved to build up a three-dimensional article. The motion can be made in a predetermined manner, which may be accomplished using any suitable CAD/CAM method and apparatus such as robotics and/or computerize machine tool interfaces.

An extrudate may be dispensed continuously or intermittently to form an initial layer and successive layers. For intermittent deposition, a dosing system may interface with a relay switch to shut off the pumps, such as the progressive cavity pumps and stop the flow of reactive materials. Any suitable switch such as an electromechanical switch that can be conveniently controlled by any suitable CAD/CAM methodology can be used.

A deposition system can include an in-line static and/or dynamic mixer as well as separate pressurized pumping compartments to hold the at least two components and feed the materials into the static and/or dynamic mixer. A mixer such as an active mixer can comprise a variable speed central impeller having high shear blades within a conical nozzle. A range of conical nozzles may be used which have an exit orifice dimension, for example, from 0.2 mm to 50 mm, from 0.5 mm to 40 mm, from 1 mm to 30 mm, or from 5 mm to 20 mm.

A range of static and/or dynamic mixing nozzles may be used which have, for example, an exit orifice dimension from 0.6 mm to 2.5 mm, and a length from 30 mm to 150 mm. For example, an exit orifice diameter can be from 0.2 mm to 4.0 mm, from 0.4 mm to 3.0 mm, from 0.6 mm to 2.5 mm, from 0.8 mm to 2 mm, or from 1.0 mm to 1.6 mm. A static mixer and/or dynamic can have a length, for example, from 10 mm to 200 mm, from 20 mm to 175 mm, from 30 mm to 150 mm, or from 50 mm to 100 mm. A mixing nozzle can include a static and/or dynamic mixing section and a dispensing section coupled to the static and/or dynamic mixing section. The static and/or dynamic mixing section can be configured to combine and mix the first and second components. The dispensing section can be, for example, a straight tube having any of the above orifice diameters. The length of the dispensing section can be configured to provide a region in which the components can begin to react and build viscosity before being deposited on the article. The length of the dispensing section can be selected, for example, based on the speed of deposition, the rate of reaction of the first and second components, and the desired viscosity.

First and second components can have a residence time in the static and/or dynamic mixing nozzle, for example, from 0.25 seconds to 5 seconds, from 0.3 seconds to 4 seconds, from 0.5 seconds to 3 seconds, or from 1 seconds to 3 seconds. Other residence times can be used as appropriate based on the curing chemistries and curing rates.

In general, a suitable residence time is less than the gel time of the composition. A suitable gel time can be less than 10 min, less than 8 min, less than 6 min, less than 5 min, less than 4 min, less than 3 min, less than 2 min, or less than 1 min. A gel time of the composition can be, for example, from 0.5 min to 10 min, from 1 min to 7 min, from 2 min to 6 min, or from 3 min to 5 min. As used herein, “gel time” refers to the time it takes for a resin system, once all ingredients are combined or mixed together, to gel or become so viscous that it is no longer liquid.

Compositions provided by the present disclosure can have a volume flow rate, for example, from 0.1 mL/min to 20,000 mL/min, such as from 1 mL/min to 12,000 mL/min, from 5 mL/min to 8,000 mL/min, or from 10 mL/min to 6,000 mL min. The volume flow rate can depend, for example, on the viscosity of the composition, the extrusion pressure, the nozzle diameter, and the reaction rate of the first and second components.

A composition can be used at a print speed, for example, from 1 mm/sec to 400 mm/sec, such as from 5 mm/sec to 300 mm/sec, from 10 mm/sec to 200 mm/sec, or from 15 mm/sec to 150 mm/sec. The printed speed can depend, for example, on the viscosity of the composition, the extrusion pressure, the nozzle diameter, and the reaction rate of the components. The print speed refers to the speed at which a nozzle used to extrude a composition move with respect to a surface onto which the composition is being deposited.

A composition can have a gel time, for example, less than 5 minutes, less than 4 minutes, less than 3 minutes, less than 2 minutes, less than 1 minute, less than 45 seconds, less than 30 seconds, less than 15 seconds, or less than 5 seconds. A composition can have a gel time, for example, from 0.1 seconds to 5 minutes, from 0.2 seconds to 3 minutes, from 0.5 seconds to 2 minutes, from 1 second to 1 minute, or from 2 seconds to 40 seconds. Gel time is considered as the time following mixing when the composition is no longer stirrable by hand.

A static and/or dynamic mixing nozzle can be heated or cooled to control, for example, the rate of reaction between the first and second components and/or the viscosity of the first and second components. An orifice of a deposition nozzle can have any suitable shape and dimensions. A system can comprise multiple deposition nozzles. The nozzles can have a fixed orifice dimension and shape, or the nozzle orifice can be controllably adjusted. The mixer and/or the nozzle may be cooled to control an exotherm generated by the reaction of the first and second components.

Methods provided by the present disclosure include printing the composition on a fabricated part. Methods provided by the present disclosure include directly printing parts.

Using the methods provided by the present disclosure parts can be fabricated. The entire part can be formed from one of the compositions disclosed herein, one or more portions of a part can be formed from one of the compositions disclosed herein, one or more different portions of a part can be formed using the compositions disclosed herein, and/or one or surfaces of a part can be formed from a composition provided by the present disclosure. In addition, internal regions of a part can be formed from a composition provided by the present disclosure.

### Coatings and Formed Parts and Uses Thereof

Coatings, layers, films, and the like, and formed parts, are provided which, in an at least partially dried or cured state, surprisingly may have:
(a) a thermal conductivity of at least 0.5 W/m-K measured using a Modified Transient Plane Source method conformed to ASTM D7984, such as at least 0.75 W/m-K, such as at least 1 W/m-K, such as at least 1.5 W/m-K, such as at least 2 W/m-K, such as at least 3 W/m-K;
(b) a lap shear strength of at least 0.1 MPa measured according to ASTM D1002-10 using an Instron 5567 machine in tensile mode with a pull rate of 10 mm per minute, such as at least 0.5 MPa, such as at least 1 MPa, such as at least 2 MPa, such as at least 3 MPa, such as at least 5 MPa, such as at least 6 MPa, such as at least 7 MPa, such as at least 8 MPa, such as at least 8.5 MPa, such as at least 9 MPa, such as at least 9.5 MPa, such as at least 10 MPa;
(c) a tensile strength of at least 5 MPa measured according to ASTM D-412 using an Instron 5567 machine in tensile mode with a pull rate of 10 mm per minute, such as at least 8 MPa, such as at least 9 MPa, such as at least 10 MPa, such as least 12 MPa, such as at least 14 MPa, such as at least 17 MPa, such as at least 19 MPa, such as at least 20 MPa, such as at least 21 MPa, such as at least 22 MPa, such as at least 23 MPa; and/or
(d) an elongation of 1% to 300%, such as 10% to 200% measured according to ASTM D-412 using an Instron 5567 machine in tensile mode with a pull rate of 10 mm per minute.

Such coatings and/or formed parts may be formed from the compositions disclosed herein.

It was unexpectedly discovered that compositions comprising an isocyanate functional prepolymer formed as a reaction product of reactants comprising a polyisocyanate and a trifunctional polyester polyol or a trifunctional polyether polyol demonstrated the improved mechanical properties described above.

Compositions disclosed herein may be used to form coatings and the like and to provide a substrate with a coating having, in an at least partially cured state,
(a) a thermal conductivity of at least 0.5 W/m-K measured using a Modified Transient Plane Source method conformed to ASTM D7984, such as at least 0.75 W/m-K, such as at least 1 W/m-K, such as at least 1.5 W/m-K, such as at least 2 W/m-K, such as at least 3 W/m-K;
(b) a lap shear strength of at least 0.1 MPa measured according to ASTM D1002-10 using an Instron 5567 machine in tensile mode with a pull rate of 10 mm per minute, such as at least 0.5 MPa, such as at least 1 MPa, such as at least 2 MPa, such as at least 3 MPa, such as at least 5 MPa, such as at least 6 MPa, such as at least 7 MPa, such as at least 8 MPa, such as at least 8.5 MPa, such as at least 9 MPa, such as at least 9.5 MPa, such as at least 10 MPa;
(c) a tensile strength of at least 5 MPa measured according to ASTM D-412 using an Instron 5567 machine in tensile mode with a pull rate of 10 mm per minute, such as at least 8 MPa, such as at least 9 MPa, such as at least 10 MPa, such as least 12 MPa, such as at least 14 MPa, such as at least 17 MPa, such as at least 19 MPa, such as at least 20 MPa, such as at least 21 MPa, such as at least 22 MPa, such as at least 23 MPa; and/or
(d) an elongation of 1% to 300%, such as 10% to 200% measured according to ASTM D-412 using an Instron 5567 machine in tensile mode with a pull rate of 10 mm per minute.

### Substrates

Compositions described herein may be coated or deposited on, or

otherwise contacted with, any substrate or surface, such as, but not limited to metals or metal alloys, polymeric materials, such as plastics including filled and unfilled thermoplastic or thermoset materials, and/or composite materials. Other suitable substrates include, but are not limited to, glass or natural materials such as wood. Substrates may include two or more of any different materials in any combination, such as, but not limited to, two different metals, or a metal and a metal alloy, or a metal and a metal alloy and one or more composite materials.

Suitable substrates may include, but are not limited to, both flexible and rigid metal substrates such as ferrous metals, aluminum, aluminum alloys, magnesium, titanium, copper, and other metal and alloy substrates. The ferrous metal substrates may include, for example, iron, steel, and alloys thereof. Non-limiting examples of useful steel materials include cold rolled steel, nickel plated cold rolled steel, galvanized (zinc coated) steel, electrogalvanized steel, stainless steel, pickled steel, zinc-iron alloy such as GALVANNEAL, and combinations thereof. Aluminum alloys, such as those, for example, of the 1XXX, 2XXX, 3XXX, 4XXX, 5XXX, 6XXX, 7XXX, or 8XXX series as well as clad aluminum alloys and cast aluminum alloys, such as those, for example, of the A356, 1XX.X, 2XX.X, 3XX.X, 4XX.X, 5XX.X, 6XX.X, 7XX.X, or 8XX.X series also may be used as the substrate. The substrate also may comprise, for example, magnesium, such as magnesium alloys of the AZ31B, AZ91C, AM60B, or EV31A series, titanium and/or titanium alloys, such as those of grades 1-36 including H grade variants, copper and copper alloys, or other non-ferrous metals, as well as alloys of these materials. The substrate may comprise a composite material such as a plastic, fiberglass and/or carbon fiber composite.

It will also be understood that the substrate may comprise a bare substrate or the substrate may be pretreated or pre-coated, at least in part, with one or more layers. Suitable pretreatment solutions may include but are not limited to a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The substrate may be in any form, such as, without limitation, a sheet, a foil, a laminate foil, a pad, a fabricated part, a component, or an article. Compositions comprising the materials disclosed herein may be used to coat a substrate, such as by depositing, applying or contacting the compositions to a substrate surface. The compositions, in an at least partially cured state, may be used in any form, such as but not limited to, a coating, a sealant, an adhesive, a pottant or an encapsulant, such as a solid, gel or foam, a pad, such as a pad formed in-situ or a discrete pre-manufactured or pre-formed pad.

In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

The compositions disclosed herein are not limited and may be particularly suitable for use in various industrial or transportation applications including automotive applications, commercial applications, rail locomotive, marine applications and/or aerospace applications. Suitable substrates for use in the present disclosure include those that are used in the assembly of vehicular bodies (for example., without limitation, door, body panel, trunk deck lid, roof panel, hood, roof and/or stringers, rivets, landing gear components, and/or skins used on an aircraft), vehicular frames, vehicular parts, motorcycles, wheels, and industrial structures and components. As used herein, “vehicle” or variations thereof includes, but is not limited to, civilian vehicles, light and heavy commercial vehicles, civilian and military aircraft, and/or land vehicles such as cars, motorcycles, and/or trucks.

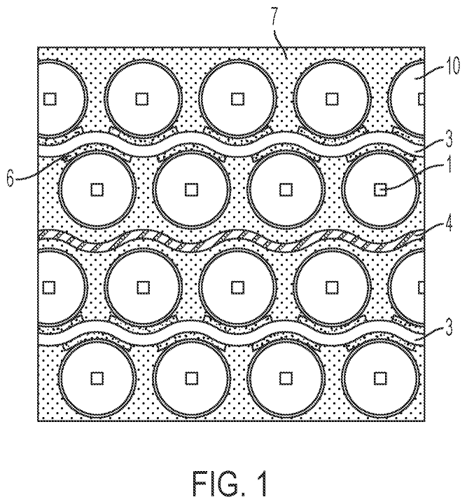

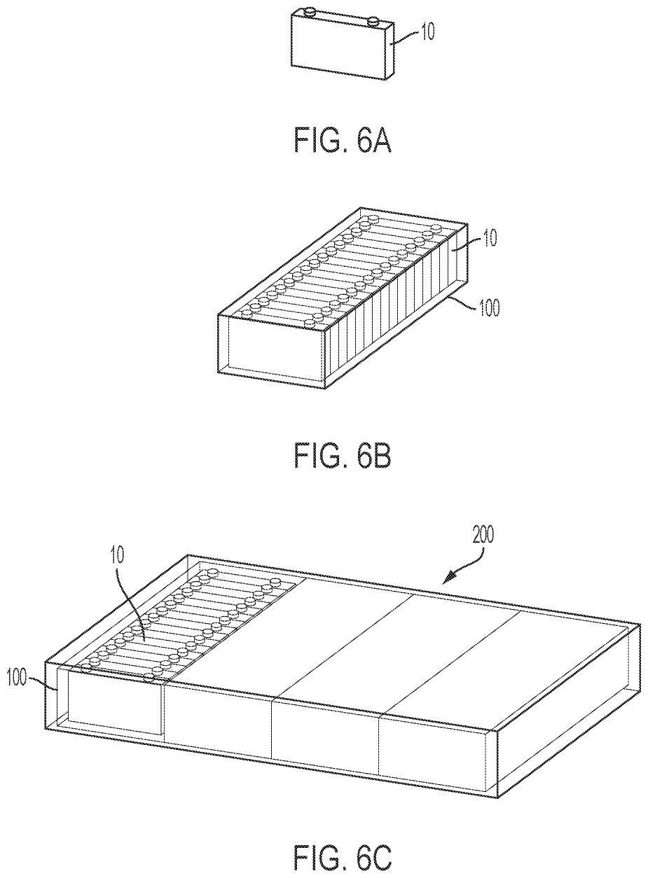

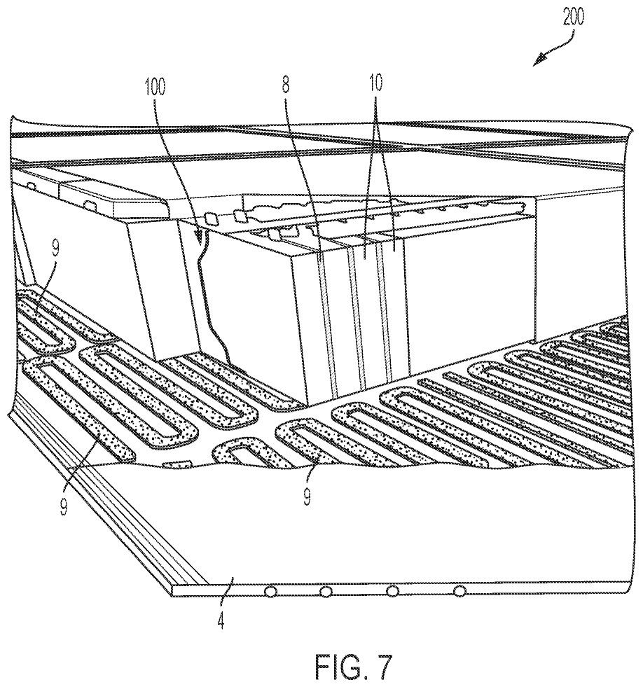

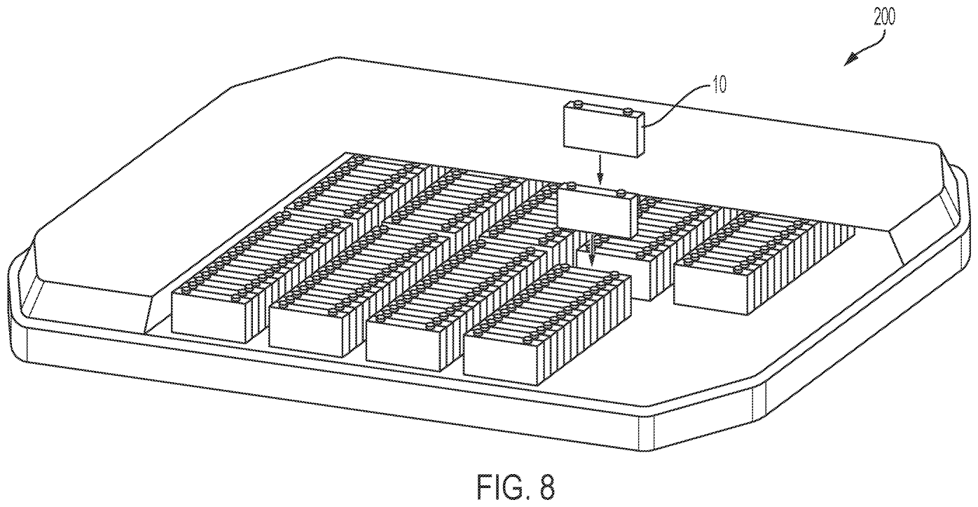

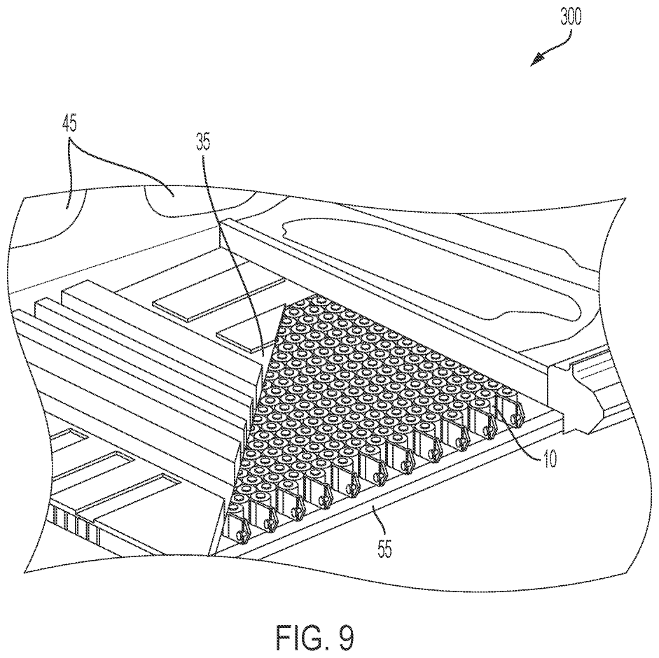

FIGS. 1 to 9 illustrate non-limiting examples of battery assembly components and constructions as well as non-limiting applications or use of compositions as disclosed herein in said battery assemblies. Although FIGS. 1 to 9 illustrate specific examples of cell shapes and cell arrangements, cells may be arranged in any configuration known to those skilled in the art. Additionally, the compositions disclosed herein, in an at least partially cured state, may be used to form pads, adhesives, coatings, pottants and the like, to provide thermal protection between battery cells, within battery modules and/or within battery packs. These materials may be used on any surface or in any space within such battery assemblies. For example, compositions disclosed herein also may be useful in battery assemblies including, but not limited to, cell to module (FIGS. 3, 4, 6B), module to pack (FIGS. 6C, 7), cell to pack (FIG. 8), and cell to chassis battery assemblies (FIG. 9). Such battery assemblies may be used in, but not limited to, any aforementioned application.

Battery assemblies may be any combination of one or more battery cells, the interconnects which provide electrical conductivity between them, as well as ancillary components such as, in non-limiting examples, control electronics and components that ensure the necessary structural mechanical and environmental requirements for the operation of a specific battery (for example, without limitation, cell interconnectors such as wires, battery pack enclosures including trays and lids, module enclosures, module frames and frame plates, module racking, cooling and heating components including cooling plates, cooling fins, and cooling tubes, electrical busbars, battery management systems, battery thermal management systems, chargers, inverters and converters).

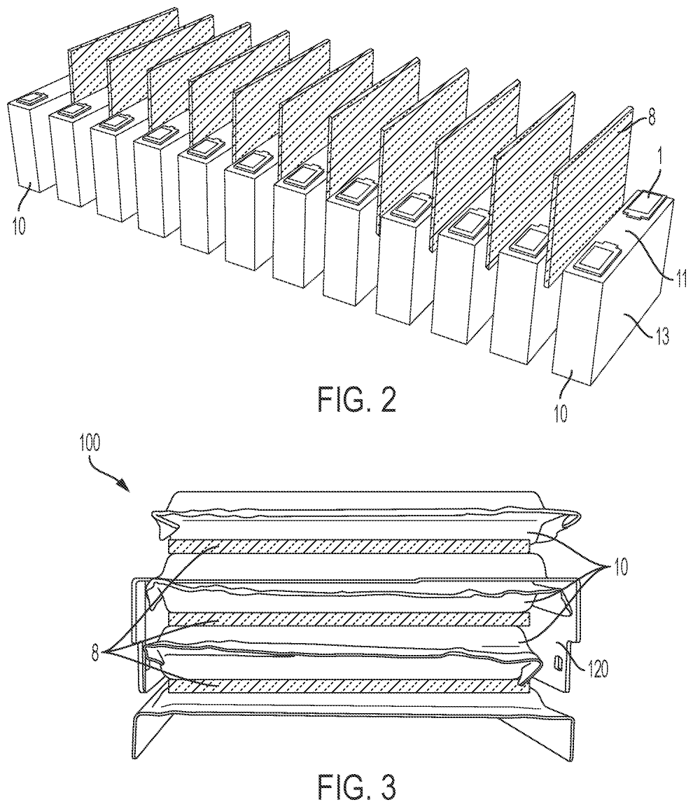

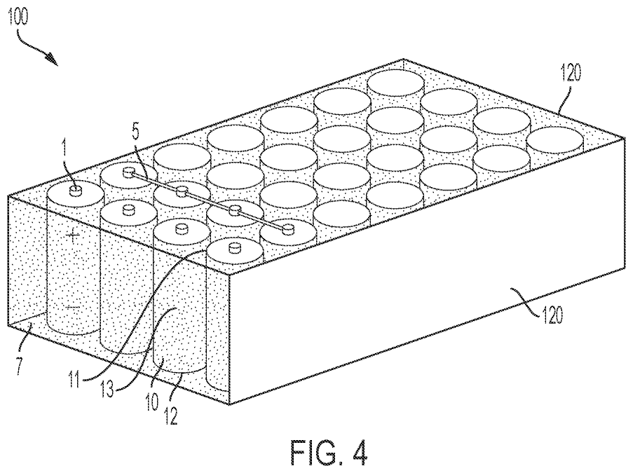

Battery cells 10 are generally single unit energy storage containers that may be connected in series or in parallel. Battery cells may be any suitable size or shape known to those skilled in the art, such as but not limited to, cylindrical (FIGS. 1, 4 and 9), prismatic (FIGS. 2, 5-8) and/or pouch (FIG. 3). Battery cells 10 are enclosed to provide desired mechanical protection and environmental isolation of the cell. For example, cylindrical and prismatic cells may be encased in metal cans, cases, and lids, while pouch cells may be enclosed in multilayer laminate foils. Battery terminals 1 connect the electrodes inside the battery cell to the electrical circuit outside the battery cell, with one being a positive terminal and the other being a negative terminal. As illustrated in FIG. 4, battery cells 10 may be connected by interconnector wires 5 with other battery cells 10 in series or in parallel to enable an electric current to flow between cells 10.

As illustrated in FIGS. 3 and 4, battery cells 10 may be arranged in modules 100 comprising multiple cells 10 connected in series or in parallel. The modules 100 may include an at least partial enclosure of the arranged cells 10. Ancillary components, such as those aforementioned, may be included. Spaces of any dimensions may be located between the plurality of cells, ancillary components, base, and/or any interior surface of the module wall or other enclosure 120.

FIG. 1 illustrates a top-down view of cylindrical battery cells 10 having terminals 1. As shown, the cells are arranged in rows with either cooling tubes 3 or dielectric insulation paper (e-paper) 4 between them. As shown, materials, such as adhesive 6 and/or pottants 7 optionally formed from the compositions disclosed herein in an at least partially cured state, may be positioned between the cells 10, cooling tubes 3 and/or e-paper 4.

FIG. 2 illustrates an exploded isometric view of an array of prismatic battery cells 10. As shown, each prismatic cell 10 may comprise a top 11, a bottom, and walls 13 positioned between the top and bottom and each having a surface. As shown, materials, such as pads 8 formed from the compositions disclosed herein in an at least partially cured state, may be positioned between surfaces of cell walls 13 of adjacent cells 10.

FIG. 3 illustrates a cut-out front view of an array of pouch battery cells 10 in a module 100. The module walls 120 at least partially encase the cells 10. As shown, materials, such as pads 8 formed from the compositions disclosed herein in an at least partially cured state, may be positioned between surfaces of cells 10.

FIG. 4 illustrates an isometric view of cylindrical cells 10 in a battery module 100. Each cell may comprise a top 11, a bottom 12, and walls 13 positioned between the top and bottom and each having a surface. The top 11 and the bottom 12 may be oppositely charged terminals with one being a positive terminal 1 and the other being a negative terminal (not shown). The battery cells may be connected at their terminals by interconnectors such as wires 5 and the like to enable an electric current to flow between the electric cells. The module 100 or module walls 120 may form a space having a volume. The cells 10 may be positioned within the space to consume a portion of the volume. The material, such as a pottant 7 formed from the compositions disclosed herein in an at least partially cured state, may be positioned, formed from the coating compositions disclosed herein may be positioned within the space to consume at least a portion of the volume such that the material is adjacent to a surface of a cell wall 13 and/or an interior surface of at least one of the walls 120 of the module 100.

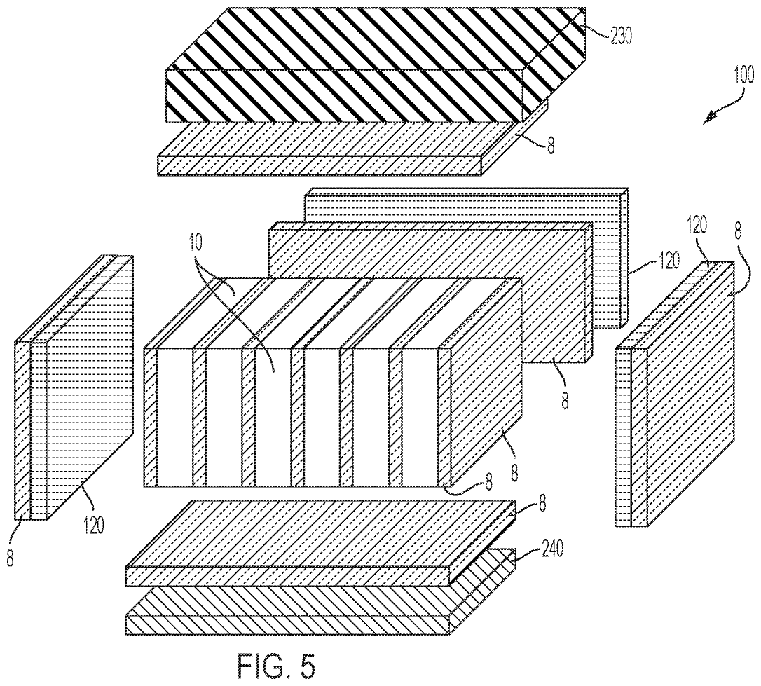

FIG. 5 illustrates an exploded perspective view of a battery module 100 comprised of one or more arrays of battery cells 10, a cooling fin 230, and a cooling plate 240. Materials, such as pads 8 formed from the compositions disclosed herein in an at least partially cured state, may be positioned between cells 10. Additional pads 8 may be positioned between the cells 10, the cooling fin 230, the cooling plate 240, and/or an interior surface of walls 120. Other pads 8 may be positioned adjacent an exterior surface of the walls 120.

FIG. 6 illustrates an isometric view of a battery cell 10 (FIG. 6A) to battery module 100 (FIG. 6B) to battery pack 200 (FIG. 6C) battery assembly. The battery module 100 comprises a plurality of battery cells 10 and the battery pack 200 comprises a plurality of battery modules 100.

FIG. 7 illustrates a perspective view of a battery pack 200 cutout. The battery pack includes a plurality of battery modules 100 and cells 10 within each module 100. The base of the battery pack 200 comprises a cooling plate 240. Materials, such as adhesives, 9 formed from the compositions disclosed herein in an at least partially cured state, may be positioned between the cooling plate 240 and interior surface of a wall of the battery pack 200. Materials, such as pads 8 formed from the compositions disclosed herein in an at least partially cured state, may be positioned between cells 10 within modules 100.

FIG. 8 illustrates an isometric view of a cell 10 to pack battery 200 assembly. Cells 10 are arranged within the pack 200 (without being in separate modules).

In other cases, the battery cells may be arranged on or within an article such as, but not limited to, a cell to chassis battery assembly, as illustrated in FIG. 9, wherein one or more cells is used to construct the battery assembly without prior assembly of the cells into modules and/or packs. FIG. 9 illustrates an isometric cut-out view of a cell to chassis battery assembly 300. Cells 10 are arranged on a base comprising the undercarriage 55 and supported by the vehicle frame 45 and under the vehicle interior floor 35.

Any battery assembly may further comprise a thermal management system comprising air or fluid circuits which may be liquid based (for example glycol solutions) or direct refrigerant based.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Synthesis of Isocyanate Functional Prepolymer

### Synthesis Example 1

An isocyanate prepolymer was prepared from the following charges shown in Table 1:

TABLE 1
Synthesis Example 1: Tri-functional polyether aromatic isocyanate

| | |
|---|---|
| Ingredients | Parts by weight |

Charge #1

| | |
|---|---|
| Suprasec 2447 ¹ | 450.00 |

Charge #2

| | |
|---|---|
| Voranol CP 6001² | 392.25 |

¹ Suprasec 2447 is commercially available from Huntsman.
²Voranol CP 6001 is commercially available from Dow Chemical.

Charge 1 was added to a 2000 mL, 4-necked flask equipped with a motor driven stainless steel stir blade, a water-cooled condenser, a nitrogen blanket, and a heating mantle with a thermometer connected through a temperature feedback control device. Charge #2 was added into the reactor over 1 hour. The reaction mixture was slowly heated to 80° C. The reaction mixture was held at 80° C. until the isocyanate equivalent weight (NCO EQ WT was stalled around 256.7 by titration (determined using a Metrohm 888 Titrando; titration by dissolving a sample (˜2.00g) of the mixture in 30 mL of a solution comprised of 20 mL of dibutylamine and 980 mL of n-methyl pyrrolidone, followed by titration with 0.2 N HCl solution in isopropanol titration agent).

### Synthesis Example 2

An isocyanate prepolymer was prepared from the following charges shown in Table 2:

TABLE 2
Synthesis Example 2: Tri-functional polyester aromatic isocyanate

| | |
|---|---|
| Ingredients | Parts by weight |

Charge #1

| | |
|---|---|
| Suprasec 2447 ¹ | 900.00 |

Charge #2

| | |
|---|---|
| Capa 3091² | 120.42 |

¹ Suprasec 2447 is commercially available from Huntsman.
²Capa 3091 is commercially available from Ingevity.

Charge 1 was added to a 2000 mL, 4-necked flask equipped with a motor driven stainless steel stir blade, a water-cooled condenser, a nitrogen blanket, and a heating mantle with a thermometer connected through a temperature feedback control device. Charge #2 was added into the reactor dropwise over 1 hour. The reaction mixture was slowly heated to 80° C. The reaction mixture was held at 80° C. until the NCO EQ WT was stalled around 159 by titration (determined using a Metrohm 888 Titrando; titration by dissolving a sample (˜2.00 g) of the mixture in 30 mL of a solution comprised of 20 mL of dibutylamine and 980 mL of n-methyl pyrrolidone, followed by titration with 0.2 N HCl solution in isopropanol titration agent).

### Synthesis Example 3

An isocyanate prepolymer was prepared from the following charges shown in Table 3:

TABLE 3
Synthesis Example 3: Di-functional polyester aromatic isocyanate

| | |
|---|---|
| Ingredients | Parts by weight |

Charge #1

| | |
|---|---|
| Suprasec 2447 ¹ | 900.00 |

Charge #2

| | |
|---|---|
| Capa 2054² | 108.00 |

¹ Suprasec 2447 is commercially available from Huntsman.
²Capa 3091 is commercially available from Ingevity.

Charge 1 was added to a 2000 mL, 4-necked flask equipped with a motor driven stainless steel stir blade, a water-cooled condenser, a nitrogen blanket, and a heating mantle with a thermometer connected through a temperature feedback control device. Charge #2 was added into the reactor dropwise over 1 hour. The reaction mixture was slowly heated to 80° C. The reaction mixture was held at 80° C. until the NCO EQ WT was stalled around 156 by titration (determined using a Metrohm 888 Titrando; titration by dissolving a sample (˜2.00g) of the mixture in 30 mL of a solution comprised of 20 mL of dibutylamine and 980 mL of n-methyl pyrrolidone, followed by titration with 0.2 N HCl solution in isopropanol titration agent).

### Preparation of Compositions

All of the compositions shown in Table 4 were prepared according to the following procedure with a Speedmixer DAC 600FVZ (commercially available from FlackTeck inc.). The polyols, dispersants, catalysts were mixed together for about 1 min with 2350 revolutions per minutes (“rpm”) at ambient temperature, then the fillers (including conductive and non-conductive) were added into the mixture for 1 min at 2350 rpm. The mixture was then mixed together with isocyanate for another 1 min at 2350.

After that, the mixture was divided into 3 samples. One sample was transferred into an aluminum weighing dish (Fisherbrand, Catalog No. 08-732-101) and was allowed to cure for one week at ambient conditions. This sample was used for thermal conductivity testing described below. One sample was transferred into a lab-made Teflon mold (described below) and was allowed to cure for one week at ambient conditions. Five dog-bone specimens were cut from this sample for testing of tensile strength and elongation. The third sample was used for preparation of 5 1-inch wide lap shear specimens.

TABLE 4
Compositions

| | Example 1 | | | |
|---|---|---|---|---|
| Composition | (Comparative) | Example 2 | Example 3 | Example 4 |
| A Pack (isocyanate- | | | | |
| containing | | | | |
| component) | | | | |
| Synthesis | | 20 | | |
| Example 3 | | | | |
| Synthesis | | | 20 | |
| Example 2 | | | | |
| Synthesis | | | | 20 |
| Example 1 | | | | |
| Suprasec 2447 | 20 | | | |
| (Comparative) | | | | |
| Silane (Dynasilane | 0.5 | 0.5 | 0.5 | 0.5 |
| Glymo) | | | | |
| Filler | | | | |
| Nabalox 625-31 | 45 | 45 | 45 | 45 |
| B Pack (polyol- | | | | |
| containing | | | | |
| component) | | | | |
| Capa 3031 | 9.67 | 8.12 | 8.12 | 3.11 |
| Capa2043 | 4.33 | 3.64 | 3.64 | 6.5 |
| 1,4-butanediol | 0.96 | 0.8 | 0.8 | 0.32 |
| (BDO) | | | | |
| Fillers | | | | |
| Nabalox 625-31 | 45 | 45 | 45 | 45 |
| Molecular Sieves | 1.8 | 1.8 | 1.8 | 1.8 |

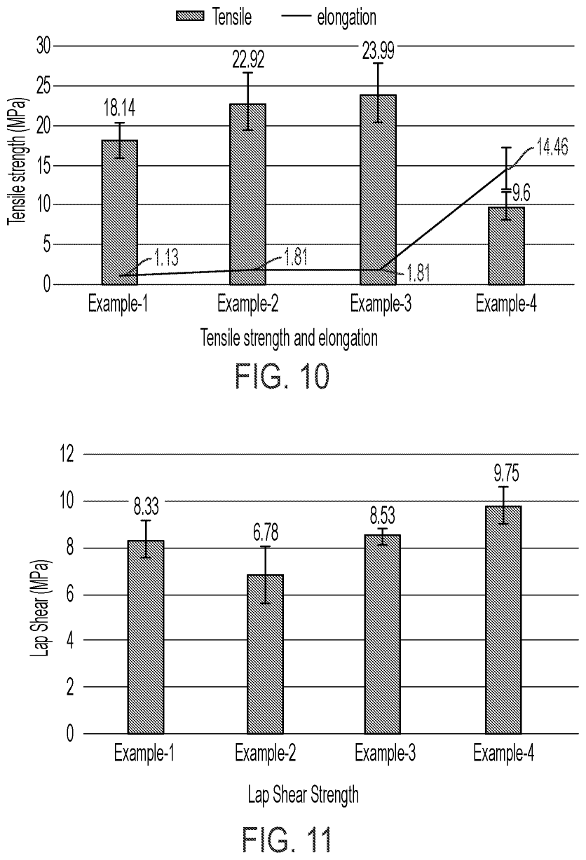

Tensile Strength and Elongation Percentage Measurement. The samples were demolded from Teflon. The dog bone sample size was 2.6 mm (thickness)×4.1 mm (width)×40 mm (gauge length) and the pull rate was 10 mm/min. The tensile strength and elongation were obtained according to standard ASTM D-412 using an Instron 5567 machine in tensile mode with a pull rate of 10 mm/min. The tensile strength and elongation of the samples are shown in FIG. 10. Data are reported as an average of the five samples that were measured.

As shown in FIG. 10, tensile strength increased in Example 3 (prepolymer made with a trifunctional polyester polyol) compared to Example 1 (comparative, which did not include an isocyanate functional prepolymer), while elongation was highest in Example 4 (prepolymer made with a trifunctional polyether polyol).

Lap Shear Strength Test. Lap joint specimens were prepared on 1.6 mm thick T3-2024 aluminum in accordance with ASTM D1002-10 using an Instron 5567 machine in tensile mode with a pull rate of 10 mm/min. Prior to bonding, the aluminum substrate was grit blasted with 54 grit aluminum oxide and cleaned with ChemKleen 490MX. Lap joints were cured at room temperature for 4 days before testing. The lab shear strength of the samples is shown in FIG. 11. Data are reported as an average of five samples that were measured.

As shown in FIG. 11, lap shear strength increased in Example 3 (prepolymer made with a trifunctional polyester polyol) and Example 4 (prepolymer made with a trifunctional polyether polyol) compared to Example 1 (comparative, which did not include an isocyanate functional prepolymer) and Example 2 (prepolymer made with a difunctional polyester polyol).

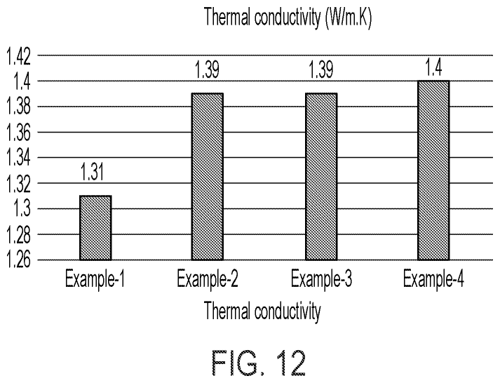

Thermal Conductivity Test. The cured samples were tested for thermal conductivity using a Modified Transient Plane Source (MTPS) method (conformed to ASTM D7984) with a TCi thermal conductivity analyzer from C-Therm Technologies Ltd. The sample size was at least 20 mm by 20 mm with a thickness of 5 mm. 500 g of load was added on top of the sample to ensure a fully contact of the sample with the flat probe. The thermal conductivity (TC) of the samples is shown in FIG. 12. TC data are reported as an average of 3 measurements made on the sample.

As shown in FIG. 12, TC was maintained across formulations tested.

The improved mechanical properties obtained in compositions comprising a prepolymer made with a trifunctional polyester polyol was unexpected.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

1. A composition, comprising:
a first component comprising an isocyanate functional prepolymer formed as a reaction product of reactants comprising a first polyisocyanate and a polyester polyol or a polyether polyol, the polyol comprising more than two hydroxyl functional groups;
a second component comprising a polyol; and
a thermally conductive filler.

2-3. (canceled)

4. The composition of claim 1, wherein the first component further comprises a non-prepolymer isocyanate.

5-8. (canceled)

9. The composition of claim 1, wherein the first polyisocyanate and/or the non-prepolymer isocyanate comprises an aromatic isocyanate.

10. The composition of claim 1, wherein the first polyisocyanate and/or the non-prepolymer isocyanate comprises an aliphatic isocyanate.

11. The composition of claim 1, wherein the first component comprises:
(a) the isocyanate functional prepolymer in an amount of 5 percent by weight to 100 percent by weight based on total weight of the first component; and/or
(b) the non-prepolymer isocyanate in an amount of 1 percent by weight to 95 percent by weight based on total weight of the first component.

12. (canceled)

13. The composition of claim 1, wherein the isocyanate functional prepolymer comprises:
(a) an equivalent weight ratio of isocyanate groups to hydroxyl groups of 21:1 to 30:1;
(b) an M_{w} of 300 g/mol to 30,000 g/mol; and/or
(c) an isocyanate equivalent weight of 150 g/eq to 15,000 g/eq.

14. The composition of claim 1, wherein the second component comprises a polyester polyol and/or a polyester polyol.

15-16. (canceled)

17. The composition of claim 1, wherein the polyester polyol of the first component and/or of the second component comprises a biobased polyol.

18-22. (canceled)

23. The composition of claim 22, wherein:
(a) the polyol of the second component comprises a diol in an amount of 4 percent by weight to 100 percent by weight based on total weight of the second component; and
(b) the polyol of the second component optionally comprises a triol in an amount of 4 percent by weight to 100 percent by weight based on total weight of the second component.

24-35. (canceled)

36. The composition of claim 1, wherein:
(a) the first component comprises the thermally conductive filler in an amount of 1 percent by weight to 95 percent by weight based on total weight of the first component;
(b) the second component comprises the thermally conductive filler in an amount of 1 percent by weight to 96 percent by weight based on total weight of second component; and/or
(c) the composition comprises the thermally conductive filler in an amount of 20 percent by weight to 95 percent by weight based on total weight of the composition.

37-43. (canceled)

44. A method of coating a substrate comprising, contacting a surface of the substrate with the composition of claim 1.

45. (canceled)

46. A substrate comprising a coating on a surface, wherein the coating, formed from the composition of claim 1, in an at least partially cured state, comprises:
(a) a thermal conductivity of at least 0.5 W/m-K measured using a Modified Transient Plane Source method conformed to ASTM D7984;
(b) a lap shear strength of at least 0.1 MPa measured according to ASTM D1002-10 using an Instron 5567 machine in tensile mode with a pull rate of 10 mm;
(c) a tensile strength of at least 5 MPa measured according to ASTM D-412 using an Instron 5567 machine in tensile mode with a pull rate of 10 mm per minute; and/or
(d) an elongation of 1% to 300% measured according to ASTM D-412 using an Instron 5567 machine in tensile mode with a pull rate of 10 mm per minute.

47-48. (canceled)

49. The substrate of claim 46, wherein the substrate comprises a vehicle, a part, an article, an appliance, a personal electronic device, a circuit board, a battery cell, a battery component, a multi-metal article, or combinations thereof.

50. The substrate of claim 49, wherein the vehicle comprises an automobile or an aircraft.

51. A battery, comprising a battery cell and the composition of claim 1 in an at least partially cured state.

52. The battery of claim 51, wherein the battery cell and the composition are housed in a module.

53. The battery of claim 51, wherein the battery cell and the composition are housed in a pack.

54. The battery of claim 52, wherein the module is housed in a pack.

55. The battery of claim 51, wherein the battery and the composition are adjacent to a vehicle chassis.

56. (canceled)

57. The battery of claim 51, wherein the composition, in the at least partially cured state, comprises:
(a) a thermal conductivity of at least 0.5 W/m-K measured using a Modified Transient Plane Source method conformed to ASTM D7984;
(b) a lap shear strength of at least 0.1 MPa measured according to ASTM D1002-10 using an Instron 5567 machine in tensile mode with a pull rate of 10 mm per minute;
(c) a tensile strength of at least 5 MPa measured according to ASTM D-412 using an Instron 5567 machine in tensile mode with a pull rate of 10 mm per minute; and/or
(d) an elongation of 1% to 300% measured according to ASTM D-412 using an Instron 5567 machine in tensile mode with a pull rate of 10 mm per minute.

58-60. (canceled)
